(19) United States
(12) Patent Application Publication
(10) Pub. No.: US 2016/0203516 A1
(43) Pub. Date: Jul. 14, 2016

(54) DISPLAYING ADVERTISEMENTS BASED ON RECEIVED INDICATIONS OF INTEREST

(71) Applicant: Microsoft Technology Licensing, LLC, Redmond, WA (US)

(72) Inventor: Carlos Antonio Moreno Magrans, Sammamish, WA (US)

(21) Appl. No.: 14/596,313

(22) Filed: Jan. 14, 2015

(51) Int. Cl. G06Q 30/02

(52) U.S. Cl. CPC G06Q 30/0257

(57) ABSTRACT

An application, such as a smart phone application, displays advertisements, such as banner advertisements, while the application is being used. When the user indicates an interest in a displayed advertisement, the application rewards the user by allowing the application to be used without displayed advertisements. The indication of interest can be a selection of the advertisement, or watching a video content item associated with the advertisement. The reward may be not displaying advertisements for a period of time such as a day or a week, or may be not displaying advertisements for some number of usages of the application.

### BACKGROUND

Many forms of digital entertainment are provided free to users, and rely on advertising revenue to pay for the costs associated with providing and creating the digital entertainment. For example, a smart phone application, such as a game, may be provided free to users. While the application is played, an advertisement, such as a banner advertisement, may be displayed along with the application. An advertiser associated with the advertisement may pay a publisher of the application for displaying the advertisement (i.e., impressions), and may pay for any selections or conversions that may occur with respect to the advertisement in the application.

While more and more publishers are adopting the above described advertising model, there are many drawbacks associated with the model. One drawback is that as the use of in-application advertisement has increased, users have become accustomed to the advertisements and are able to ignore the advertisements while they utilize the applications. For advertisers, this may result in paying for advertisement impressions that were not fully considered by users. For publishers, this may depress the amount of money that can be charged to advertisers for impressions, and may lead to fewer conversions which often generate more revenue for the publishers than impressions.

### SUMMARY

An application, such as a smart phone application, displays advertisements, such as banner advertisements, while the application is being used. When the user indicates an interest in a displayed advertisement, the application rewards the user by allowing the application to be used without displayed advertisements. For example, the indication of interest can be a selection of the advertisement or watching a video content item associated with the advertisement. The reward may be not displaying advertisements for a period of time such as one day or one week, for example, or may be not displaying advertisements for some number of usages of the application.

In an implementation, a query of whether to display at least one advertisement (i.e., one or more advertisements) is received by a computing device. The query identifies an entity. In response to the query, advertisement information associated with the identified entity is retrieved by the computing device. It is determined by the computing device that the retrieved advertisement information satisfies a condition. In response to determining that the retrieved advertisement information satisfies the condition, an instruction not to display the one or more advertisements is provided by the computing device.

In an implementation, while executing an application by a computing device at a first time, an advertisement is displayed in the application. An indication of interest in the displayed advertisement is received by the computing device. In response to the indication of interest, advertisement information associated with the application is updated based on the received indication of interest by the computing device. While executing the application by the computing device at a second time after the first time, it is determined by the computing device that the updated advertisement satisfies a condition. In response to the determination, the advertisement, or a different advertisement, is not displayed in the application by the computing device.

This summary is provided to introduce a selection of concepts in a simplified form that are further described below in the detailed description. This summary is not intended to identify key features or essential features of the claimed subject matter, nor is it intended to be used to limit the scope of the claimed subject matter.

### BRIEF DESCRIPTION OF THE DRAWINGS

The foregoing summary, as well as the following detailed description of illustrative embodiments, is better understood when read in conjunction with the appended drawings. For the purpose of illustrating the embodiments, there is shown in the drawings example constructions of the embodiments; however, the embodiments are not limited to the specific methods and instrumentalities disclosed. In the drawings:

FIG. 1 is an illustration of an exemplary environment for determining whether to display advertisements;

FIG. 2 is an illustration of another exemplary environment for determining whether to display advertisements;

FIG. 3 is an illustration of an example client device;

FIG. 4 is an illustration of the client device after the indication of interest was provided by a user;

FIG. 5 is an illustration of the client device after the user has returned to the application from a web page;

FIG. 6 is an illustration of the client device including an optional starting page;

FIG. 7 is an operational flow of an implementation of a method for determining whether or not to display at least one advertisement (i.e., one or more advertisements);

FIG. 8 is an operational flow of an implementation of a method for determining whether to display an advertisement;

FIG. 9 is an operational flow of an implementation of a method for determining whether or not to display at least one advertisement (i.e., one or more advertisements) based on a count; and

FIG. 10 shows an exemplary computing environment in which example embodiments and aspects may be implemented.

### DETAILED DESCRIPTION

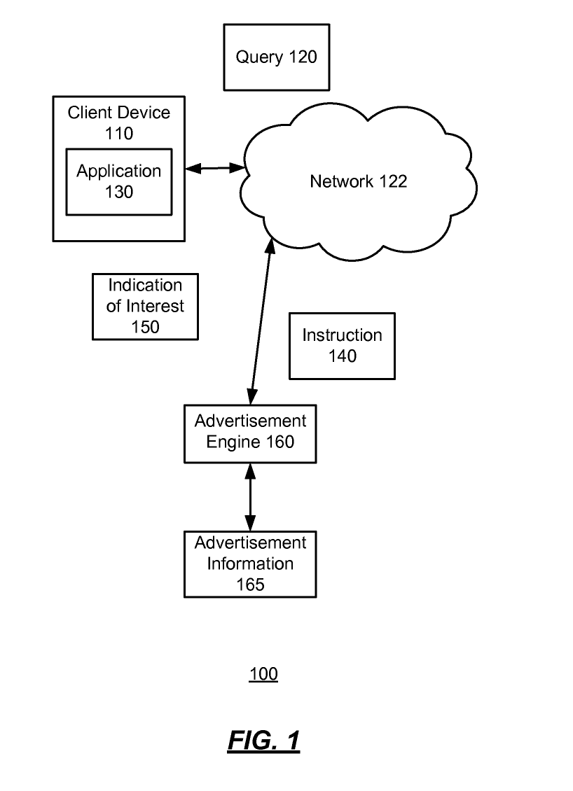

FIG. 1 is an illustration of an exemplary environment 100 for determining whether to display advertisements. The environment 100 may include a client device 110 and an advertisement engine 160 in communication through a network 122. The network 122 may be a variety of network types including the public switched telephone network (PSTN), a cellular telephone network, and a packet switched network (e.g., the Internet). Although only one client device 110 and advertisement engine 160 are shown in FIG. 1, there is no limit to the number of client devices and advertisement engines that may be supported.

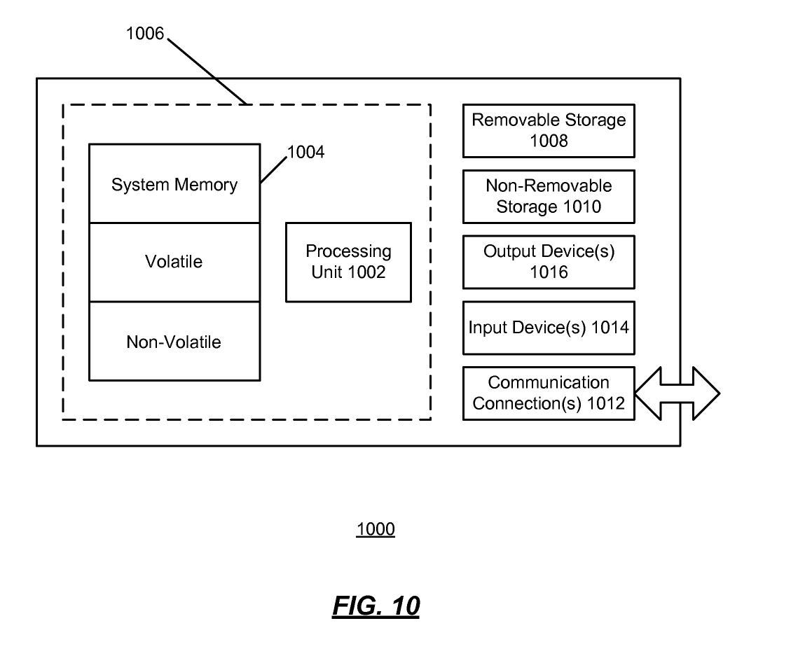

Both the client device 110 and the advertisement engine 160 may be implemented together or separately using a general purpose computing device such as is the computing device 1000 described with respect to FIG. 10. The client device 110 may be a smart phone, video game console, laptop computer, set-top box, personal/digital video recorder, or any other type of computing device.

The client device 110 may execute at least one application 130 (i.e., one or more applications 130). The applications 130 may be a variety of application types including games, word processors, media viewers or renderers, or any other type of application that is capable of displaying or rendering an advertisement while the application 130 is being executed. In implementations where the client device 110 is a smart phone or tablet computer, the application 130 may be a free or reduced cost version of an application that includes in-game advertisements. In implementations where the client device 110 is a desktop or laptop computer, the application 130 may be a web browser. In implementations where the client device 110 is a set-top box, the application 130 may be an application used to view movies or television programs through the set-top box.

As described above, users of applications 130 have become used to ignoring or disregarding advertisements displayed by applications 130. In order to incentivize users to interact or view advertisements displayed by applications 130, in some implementations, the applications 130 may reward users for interacting with advertisements by abstaining from displaying further advertisements in the application 130 for some period of time or for some number of uses of the application 130. Such advertisement interactions are referred to herein as “indications of interest” and are illustrated in FIG. 1 as the indication of interest 150. Indications of interest may include, for example, a “click” or selection of a displayed advertisement, the watching of a video content item associated with a displayed advertisement, viewing or opening a web page associated with a displayed advertisement, downloading or purchasing an application or other product or content item associated with a displayed advertisement, or providing information requested by a displayed advertisement. Other indications of interest 150 may be supported.

Accordingly, the environment 100 may include the advertisement engine 160. The advertisement engine 160 may store or maintain advertisement information 165 for each of a plurality of entities. The entities may include, for example, users, specific applications 130, or client devices 110. The advertisement information 165 may indicate to an application 130 whether an indication of interest 150 was received for a particular entity, and therefore no advertisement, or a reduced number of advertisements, may be displayed during the execution of the application 130.

Depending on the implementation, the advertisement information 165 for an entity may be one or more of a count and a date stamp. The count may indicate the number of uses of an application 130 that the particular entity has earned. For example, an entity may receive 5, 10, 20, etc. advertisement-free or advertisement-reduced uses of an application 130 for each indication of interest 150 that is recorded for the entity.

The date stamp may be a date, or a combination of a date and a time, that indicates the date and/or time when the advertisement-free or advertisement-reduced use of an application 130 may expire for an entity. For example, an entity may receive one hour, one day, one week, etc. of advertisement-free or advertisement-reduced uses of an application 130 for each indication of interest 150 that is recorded for the entity.

When the application 130 is initially started or executed by the client device 110, the application 130 may generate a query 120. The query 120 may be a request as to whether an advertisement may be displayed while the application 130 is executing. The query 120 may be sent to the advertisement engine 160 and may indicate an entity such as the particular user who is operating the application 130, the application 130 being executed, or the client device 110.

The advertisement engine 160 may receive the query 120 and may retrieve the advertisement information 165 associated with the identified entity and may use the advertisement information 165 to determine whether or not an advertisement may be displayed by the application 130 based on whether or not a condition is satisfied by the advertisement information 165. Where the advertisement information 165 is a date stamp, the condition may be that the date and/or time indicated by the date stamp is not earlier than a current date and/or time. Where the advertisement information 165 is a count, the condition may be that the count is not less than a threshold count (e.g., zero).

In addition, the condition may be a combination of the date stamp and the count. For example, the condition may be that the date and/or time indicated by the date stamp is not earlier than a current date and/or time and that the count is not less than the threshold count.

The advertisement engine 160 may generate an instruction 140 to either display or not display an advertisement while the application 130 is executing, and may send the generated instruction 140 to the application 130 that generated the query 120. Where the advertisement information 165 is a count, and the count was greater than the threshold, the advertisement engine 160 may decrement or reduce the count before or after sending the instruction 140 to the application 130.

The application 130 may receive the instruction 140, and may determine whether or not to display advertisements while the application 130 executes. If the instruction 140 indicates that no advertisement be displayed, then the application 130 may display no advertisement while executing on the client device 110. If the instruction 140 indicates that an advertisement may be displayed, then the application 130 may display an advertisement while executing on the client device 110. Depending on the implementation, the advertisement may be displayed while the application 130 is executing as one or more of a banner advertisement, a pop-up advertisement, or an interstitial advertisement, for example. Any type of advertisement may be used.

While an advertisement is being displayed to a user of the application 130, the user of the application 130 may provide an indication of interest 150 with respect to the advertisement. The indication of interest 150 may be a selection of the displayed advertisement, or may include further action by the user such as watching a video content item associated with the advertisement, for example.

In some implementations, the application 130 may encourage the user to provide the indication of interest 150 by notifying the user that the user may use the application 130 in an advertisement-free or advertisement-reduced mode as a reward for providing the indication of interest 150. For example, the user may be notified in a splash screen associated with the application 130, or may be notified when the application 130 is initially downloaded or acquired.

In some implementations, the reward provided to the user may be dependent on the type of indication of interest 150 that is provided. For example, a user may receive five advertisement-free uses of the application 130 in exchange for selecting a displayed advertisement, ten advertisement-free uses of the application 130 in exchange for viewing a video content item associated with a displayed advertisement 130, and fifteen advertisement-free uses of the application 130 in exchange for purchasing an application or other item associated with a displayed advertisement 130.

The application 130 may provide the indication of interest 150 to the advertisement engine 160. Depending on the implementation, the indication of interest 150 may identify one or more of the user, application 130, or client device 110 associated with the indication of interest 150.

The advertisement engine 160 may receive the indication of interest 150, and may update the advertisement information 165 associated with one or more of the user, application 130, or client device 110 associated with the indication of interest 150. Where the advertisement information 165 is a date stamp, the advertisement engine 160 may update the date stamp to some future date depending on how much advertisement-free or advertisement-reduced usage that the user, application 130, or client device 110 is entitled to. Similarly, where the advertisement information 165 is a count, the advertisement engine 160 may increment the count by an amount that depends on how much advertisement-free or advertisement-reduced usage that the user, application 130, or client device 110 is entitled to. The amount or future date used to update the advertisement information 165 may be set by a user or an administrator or may be based on the type of indication of interest 150.

As described above, the advertisement information 165 may be associated with one or more of a user, an application 130, or a client device 110. In implementations, where the advertisement information 165 is associated with a user or a client device 110, the same advertisement information 165 may be used to either enable or disable advertisements for multiple applications 130 and not just the application 130 associated with the indication of interest 150. For example, a user of a first application 130 who selects or views an advertisement associated with the first application 130, may be rewarded with a limited advertisement-free experience for the first application 130, as well as a second application 130, and/or a third application 130, etc.

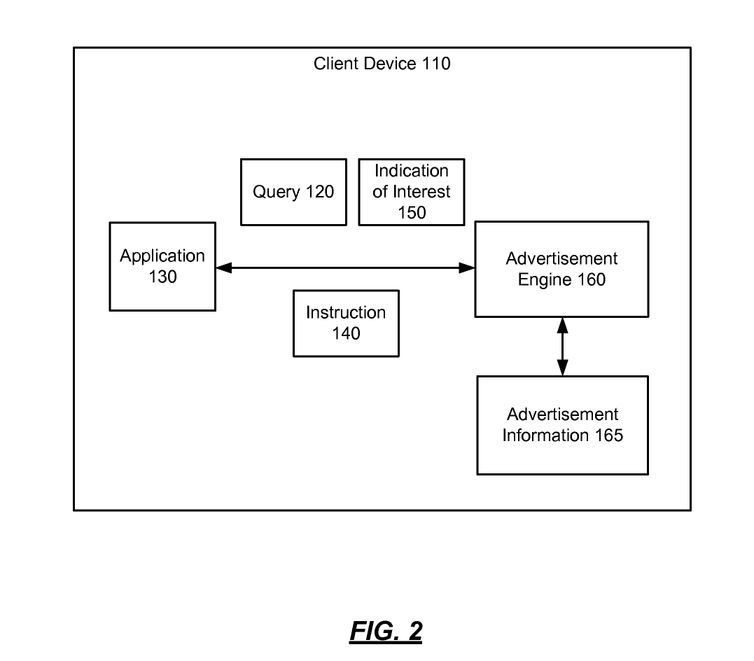

FIG. 2 is an illustration of another exemplary environment 200 for determining whether to display advertisements. In the environment 200, the advertisement engine 160 is part of the client device 110, and may also be implemented as part of the application 130. Thus, each client device 110 and/or application 130 may store and maintain its own advertisement information 165 that controls whether or not advertisements are displayed by the application 130. As shown, the query 120, the indication of interest 150, and the instructions 140 are exchanged within the client device 110 and/or the application 130. This is in contrast with the environment 100 where the advertisement engine 160 is implemented as a server external to the client device 110.

By implementing the advertisement engine 160 locally, the determination to display an advertisement may be made quickly because network delays associated with sending and receiving the query 120 and the instruction 140 may be avoided. In some implementations, the environments 100 and 200 may be combined such that the advertisement information 165 may be stored and maintained by an advertisement engine 160 external to the client device 110, and then periodically send to an advertisement engine 160 local to the client device 110 and/or the application 130. The local advertisement engine 160 may generate instructions 140 based on the locally stored advertisement information 165.

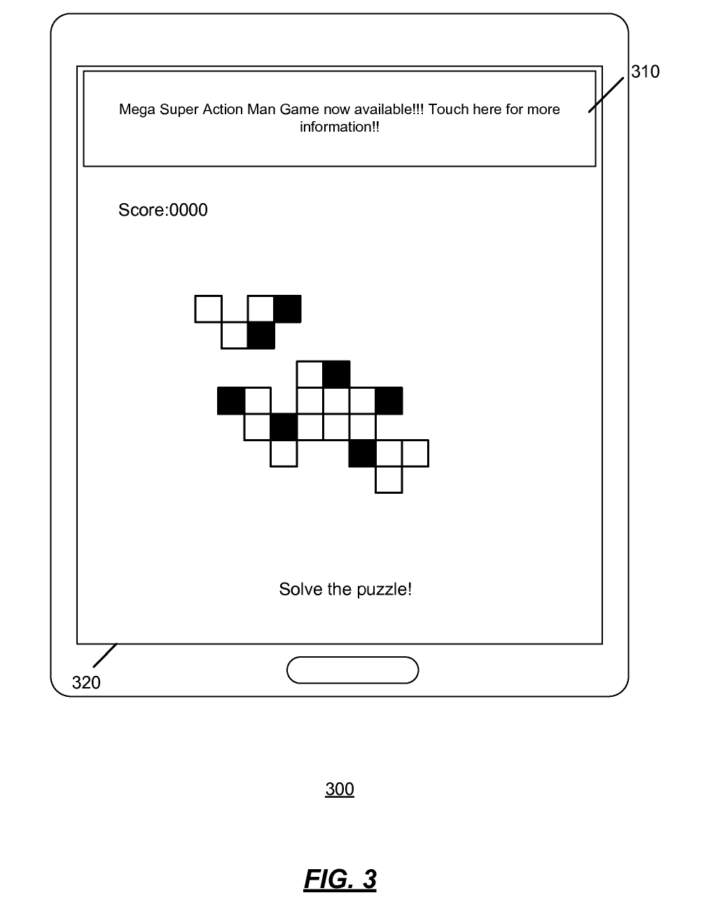

FIG. 3 is an illustration of an example client device 300. The client device 300 may be a tablet computer or a smart phone, for example; however, other types of computing devices may be used. As shown, the client device 300 is executing an application 130 that is a puzzle game. Accordingly, information associated with the application 300 is displayed in a display area 320. A user of the client device 300 may interact with the display area 320 using a touch screen or capacitive user interface, for example.

While executing the application 130, an advertisement 310 is displayed in a region (e.g., an upper region) of the display area 320. The advertisement 310 is a banner advertisement and is an advertisement for an application 130 titled “Mega Super Action Man.” The advertisement 310 invites a user to touch the advertisement 310 (in the display area 320) to receive more information regarding the advertised application.

The user of the application 130 may provide an indication of interest 150 in the advertisement 310. Depending on the implementation, the user may provide the indication of interest 150 by touching or selecting the advertisement 310 in the display area 320.

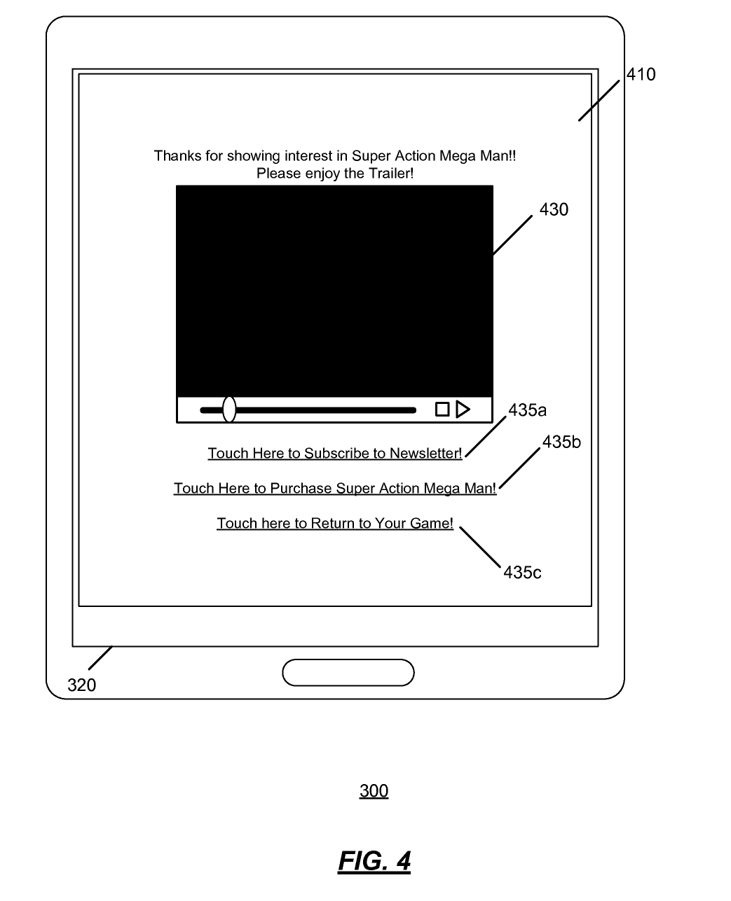

FIG. 4 is an illustration of the client device 300 after the indication of interest 150 was provided by the user. As shown, a web page 410 associated with the displayed advertisement 310 is displayed to the user in the display area 320 of the client device 300. The web page 410 is retrieved and displayed by the application 130 in response to the user providing the indication of interest 150 with respect to the advertisement 310. The web page 410 includes an embedded video player 430 that may play a trailer (i.e., video content item) for the game associated with the selected advertisement 310. In addition, the web page 410 includes a link 435a through which the user may subscribe to a newsletter associated with the advertisement 310, a link 435b through which the user may purchase the game associated with the advertisement 310, and a link 435c through which the user may return to their original application 130.

After viewing some or all of the trailer shown in the embedded video player 430, and optionally selecting one or both of the links 435a and 435b, the user may select the link 435c to return to the original application 130. In response to the selection, the application 130 may provide the indication of interest 150 to the advertisement engine 160. Depending on the implementation, the indication of interest 150 may indicate the interest shown by user when selecting the initial advertisement 310, as well as any additional interest shown by the user when selecting one or both of the links 435a or 435b. The provided indication of interest 150 may further identify some or all of the users associated with the client device 300, the client device 300 itself, and the application 130.

The advertisement engine 160 may receive the indication of interest 150, and may update the advertisement information 165 associated with one or more of the user, the client device 300, or the application 130 identified by the indication of interest 150. Depending on the implementation, the advertisement information 165 may be updated by a fixed amount (i.e., the date stamp increased by a fixed amount of time and/or the count incremented by a fixed number), or the advertisement information 165 may be updated based on the number of interactions and indications reflected by the indication of interest 150. For example, a user who selected both the links 435a and 435b may be rewarded with more advertising-free use of the application 130, than a user who only selected the link 435a, or who selected none of the links 435a and 435b.

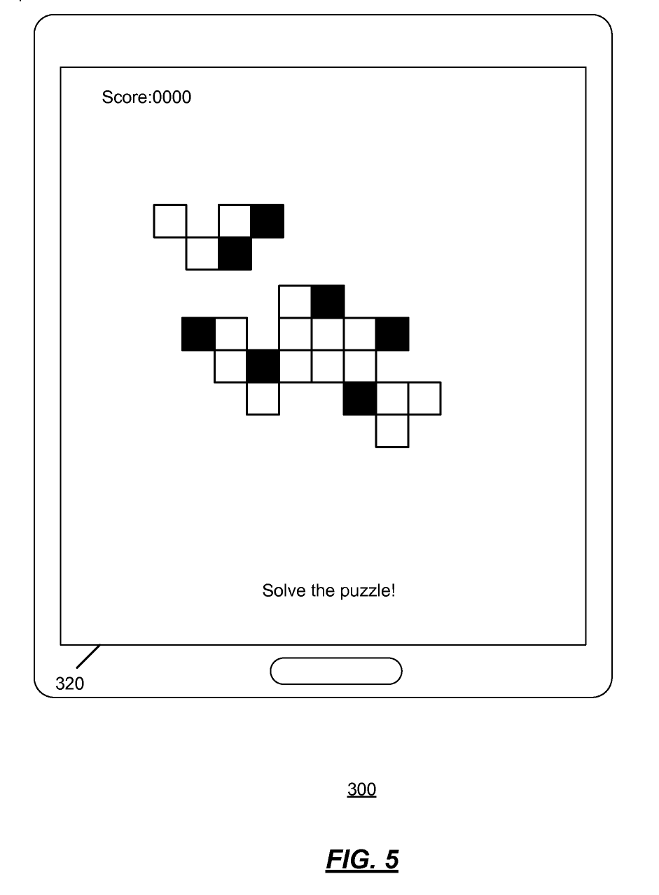

FIG. 5 is an illustration of the client device 300 after the user has returned to the application 130 from the web page 410. As shown, the application 130 is utilizing the entire display area 320, and the advertisement 310 is no longer being displayed. The application 130 may have received instructions 140 from the advertisement engine 160 reflecting the indication of interest 150 that was provided with the advertisement 310. As a reward, the application 130 is operating without the advertisement 310.

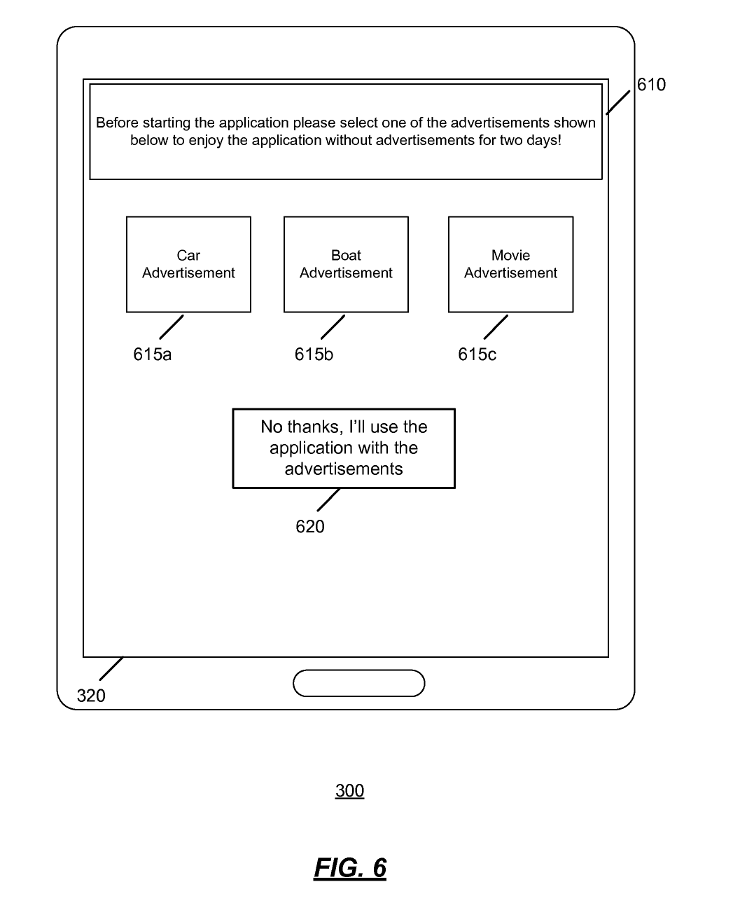

FIG. 6 is an illustration of the client device 300 including an optional starting page 610. In the example shown, a user has begun executing an application in the display area 320 of the client device 300. In order to inform the user that showing or indicating interest in advertisements may result in advertisement-free, or advertisement-reduced, use of the application 130, the user is shown the starting page 610. In the example shown, the user is presented with a choice to indicate an interest in any one of a group of advertisements (e.g., the advertisements 615a, 615b, and 615c). The user may choose to provide an indication of interest 150 by selecting any of the advertisements 615a, 615b, and 615c, or may decline to provide an indication of interest 150 by selecting the user interface element 620. If the user selects one of the advertisements 615a, 615b, and 615c, the user may utilize the application 130 without the advertisement 310 (e.g., as shown in FIG. 5). If the user declines to provide the indication of interest 150 and selects the user interface element 620, the user may utilize the application 130 with the advertisement 310 (e.g., as shown in FIG. 3).

The various features and implementations described and shown in FIGS. 3-6 are not limited to tablet or smart phone clients 300. As one example, the advertisement engine 160 may be integrated into a client device 110 such as a set-top box. The application 130 may be, for example, a digital video recorder or a streaming video application 130 integrated into the set-top box. When a user begins to view a program stored on, or streamed to, the set-top box, the user may be provided with an option to provide an indication of interest 150 with respect to one or more advertisements. Similarly as shown in FIG. 6, the user of the set-top box may be provided with the option to view one of a plurality of advertisements, and/or the option to decline to view the advertisements by selecting the user interface element 620.

If the user declines to view one of the plurality of advertisements, the user may be prevented from utilizing the “trick-play” features of the set-top box such as fast forward, preventing the user from skipping any commercials that may be integrated into the program. If the user later provides an indication of interest 150 by viewing one or more of the advertisements, then the trick-play features may be enabled allowing the user to skip the integrated commercials. The trick-play features may be enabled or disabled by the advertisement engine 160 based on the advertisement information 165 and the indications of interest 150 similarly as described above.

As another example, a user of a web page such as an online newspaper may be allowed to view an advertisement-free or an advertisement-reduced version of the online newspaper by showing an indication of interest 150 in a displayed advertisement. The advertisements on the web page may be enabled or disabled by the advertisement engine 160 based on the advertisement information 165 and the indications of interest 150 similarly as described above.

As may be appreciated, enabling advertisement-free or advertisement-reduced versions of one or more applications 130 or other services may provide advantages or improvements over conventional advertisement systems. One advantage is that publishers of applications 130 may realize additional revenue streams through increased selection or conversions of displayed advertisements. Typically, publishers receive more revenue from advertisement conversions than from advertisement impressions, therefore revenue to the publisher may be increased by encouraging users to make more conversions in exchange for fewer impressions.

Another advantage is that advertisers may receive more high-quality conversions in exchange for fewer low-quality impressions. As noted above, users have become so used to advertisements shown by applications 130, that the advertisements are easily ignored. Using the system and methods described herein, an advertiser may pay for fewer ignored impressions, and any conversions paid for may be of a high quality because the user actively chose to view or interact with the particular advertisements 130.

Another advantage is that users are incentivized to interact with displayed advertisements. In conventional advertising systems, selecting an advertisement during an application 130 results in an interruption of the application 130 without providing any real benefit to the user. By providing an advertisement-free or an advertisement-reduced use of the application 130 in exchange for the selection of an advertisement, the users are provided a real benefit in exchange for interacting with displayed advertisements that may result in an increased conversion rate for advertisers and publishers.

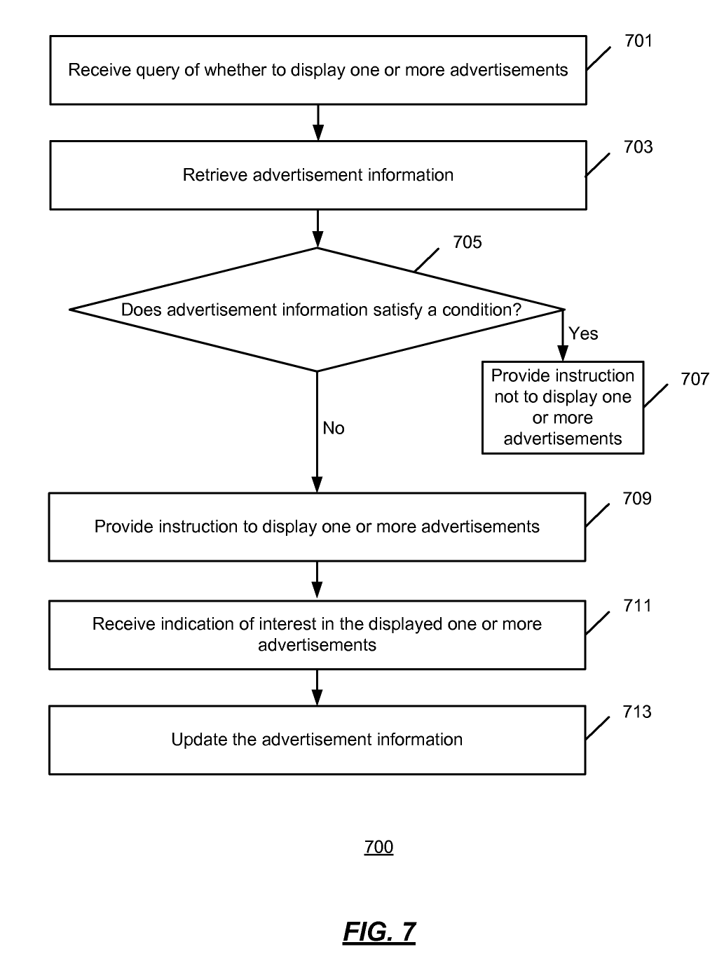

FIG. 7 is an operational flow of an implementation of a method 700 for determining whether or not to display at least one advertisement (i.e., one or more advertisements). The method 700 may be implemented by the advertisement engine 160, for example.

At 701, a query of whether to display at least one advertisement (i.e., one or more advertisements) is received. The query 120 may be received by the advertisement engine 160 from an application 130. The advertisement(s) may be one or more of banner advertisements, pop-up advertisements, or interstitial advertisements. Other types of advertisements may be supported. Depending on the implementation, the query 120 may identify an entity. The identified entity may be a user associated with a client device 110 executing the application 130, the application 130 itself, or the client device 110.

At 703, advertisement information is retrieved. The advertisement information 165 may associated with the identified entity and may be retrieved by the advertisement engine 160. The advertisement information 165 may include a count, a date stamp, or both a count and a date stamp. Other types of advertisement information 165 may be supported.

At 705, a determination is made as to whether the advertisement information satisfies a condition. The determination may be made by the advertisement engine 160. In implementations where the advertisement information 165 is date stamp, the advertisement information 165 may satisfy the condition if the date indicated by the date stamp is later than, or not earlier than, a current date. In implementations where the advertisement information 165 is a count, the advertisement information 165 may satisfy the condition if the count is greater than, or not less than, a threshold count. The threshold count may be zero, for example.

If the advertisement information 165 satisfies the condition, then the method 700 may continue at 707. Otherwise, the method 700 may continue at 709.

At 707, an instruction not to display at least one advertisement (i.e., one or more advertisements) is provided. The instruction 140 may be provided by the advertisement engine 160 to the application 130. In response to the instruction 140, the application 130 may be provided without displaying any advertisements to the user of the application 130. Alternatively, the number or size of advertisements that are displayed during the application 130 may be reduced.

At 709, an instruction to display at least one advertisement (i.e., one or more advertisements) is provided. The instruction 140 may be provided by the advertisement engine 160 to the application 130. In response to the instruction 140, the application 130 may display one or more advertisements to the user of the application 130.

At 711, an indication of interest is received. The indication of interest 150 may be received by the advertisement engine 160 from the application 130. The indication of interest 150 may be associated with the user of the application 130 selecting a displayed advertisement, viewing a video content item associated with an advertisement, visiting a web page associated with an advertisement, or downloading an application associated with an advertisement, for example. Other indications of interest 150 may be supported. The indication of interest 150 may identify the entity that provided the indication of interest 150.

At 713, the advertisement information is updated. The advertisement information 165 associated with the entity may be updated by the advertisement engine 160 to reflect the indication of interest 150, so that further uses of the application 130 by the entity may include no advertisements or a reduced number of advertisements.

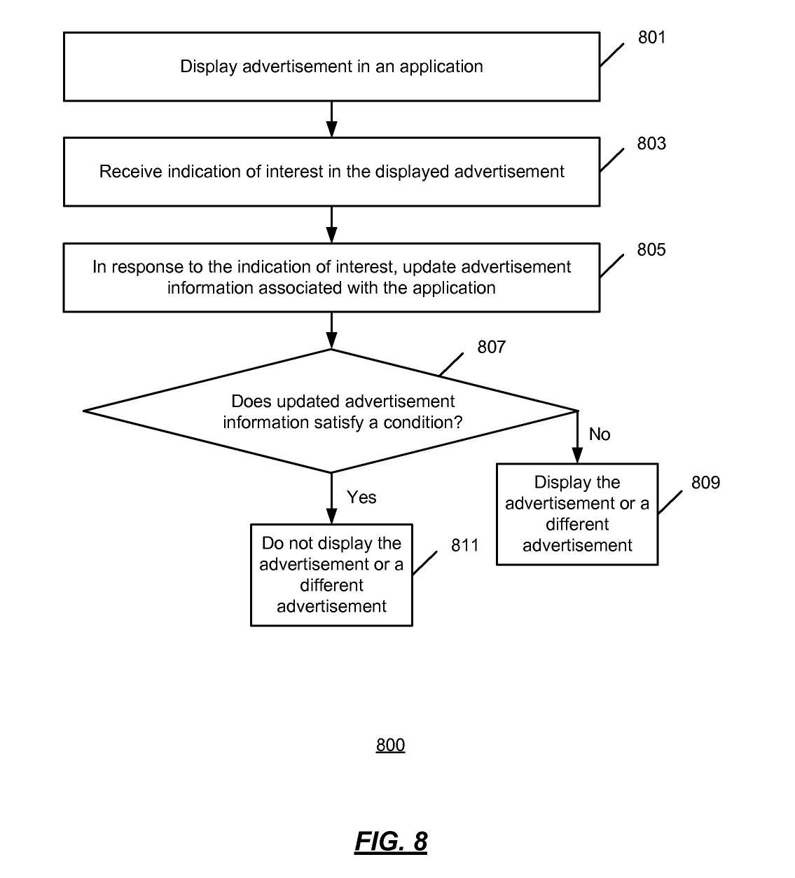

FIG. 8 is an operational flow of an implementation of a method 800 for determining whether to display an advertisement. The method 800 may be implemented by the advertisement engine 160, for example.

At 801, an advertisement is displayed in an application. The advertisement may be displayed by the application 130 to a user of the application 130 when the application 130 is executed at a first time. The advertisement may be one or more of a banner advertisement, a pop-up advertisement, or an interstitial advertisement, for example.

At 803, an indication of interest the displayed advertisement is received. The indication of interest 150 may be received by the advertisement engine 160 from the application 130. The indication of interest 150 may be associated with the user of the application 130 selecting the displayed advertisement. The indication of interest 150 may identify the application 130 that provided the indication of interest 150.

At 805, advertisement information associated with the application is updated. The advertisement information 165 associated with the application 130 may be updated by the advertisement engine 160 to reflect the indication of interest 150, so that further uses of the application 130 may include no advertisements or a reduced number of advertisements.

At 807, a determination is made as to whether the advertisement information satisfies a condition. The determination may be made by the advertisement engine 160 using the advertisement information 165 associated with the application 130 in response to a query 120 generated by the application 130. The application 130 may be executed at a second time that is after the first time when the indication of interest 150 was received.

If the advertisement information 165 satisfies the condition, the method 800 may continue at 811. Otherwise, the method 800 may continue at 809.

At 809, the previously displayed advertisement or a different advertisement is displayed by the application 130. Because the condition was not satisfied at 807, the user of the application 130 may be executed with displayed advertisements.

At 811, the previously displayed advertisement or a different advertisement is no longer displayed by the application 130. Because the condition was satisfied at 807, the application 130 may be executed without displayed advertisements.

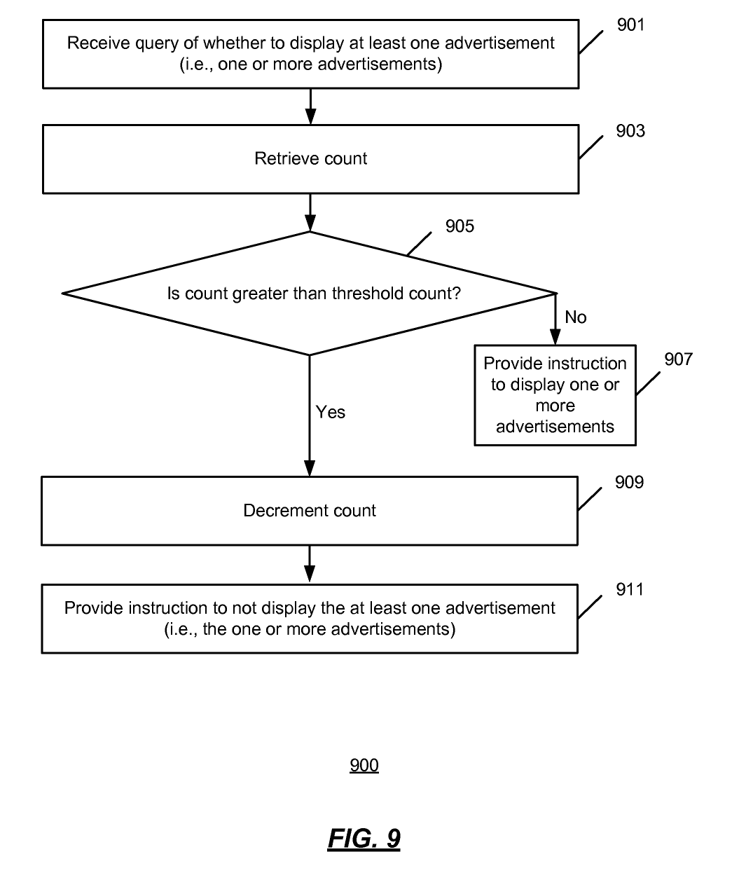

FIG. 9 is an operational flow of an implementation of a method 900 for determining whether or not to display at least one advertisement (i.e., one or more advertisements) based on a count. The method 900 may be implemented by the advertisement engine 160, for example.

At 901, a query of whether to display at least one advertisement (i.e., one or more advertisements) is received. The query 120 may be received by the advertisement engine 160 from an application 130. The query 120 may be generated by the application 130 in response to a user starting or selecting the application 130 for execution on a client device 110. The query 120 may identify an entity such as the application 130, the client device 110, or the user.

At 903, a count is retrieved. The count may associated with the identified entity and may be retrieved by the advertisement engine 160. The count may reflect a number of advertisement-free or advertisement-reduced uses of the application 130 that the entity is entitled to.

At 905, a determination is made as to whether the count is greater than a threshold count. The determination may be made by the advertisement engine 160. The threshold may be zero, for example.

If the count is greater than the threshold, then the method 900 may continue at 909. Otherwise, the method 900 may continue at 907.

At 907, an instruction to display one or more advertisements is provided. The instruction 140 may be provided by the advertisement engine 160 to the application 130. In response to the instruction 140, the application 130 display one or more advertisements to the user of the application 130.

At 909, the count is decremented. The count may be part of the advertisement information 165 associated with the entity. The count may be decremented to reflect the advertisement-free usage of the application 130 that may occur at 911.

At 911, an instruction not to display one or more advertisements is provided. The instruction 140 may be provided by the advertisement engine 160 to the application 130. In response to the instruction 140, the application 130 may not display one or more advertisements to the user of the application 130.

FIG. 10 shows an exemplary computing environment in which example embodiments and aspects may be implemented. The computing device environment is only one example of a suitable computing environment and is not intended to suggest any limitation as to the scope of use or functionality.

Numerous other general purpose or special purpose computing devices environments or configurations may be used. Examples of well-known computing devices, environments, and/or configurations that may be suitable for use include, but are not limited to, personal computers, server computers, handheld or laptop devices, multiprocessor systems, microprocessor-based systems, network personal computers (PCs), minicomputers, mainframe computers, embedded systems, distributed computing environments that include any of the above systems or devices, and the like.

Computer-executable instructions, such as program modules, being executed by a computer may be used. Generally, program modules include routines, programs, objects, components, data structures, etc. that perform particular tasks or implement particular abstract data types. Distributed computing environments may be used where tasks are performed by remote processing devices that are linked through a communications network or other data transmission medium. In a distributed computing environment, program modules and other data may be located in both local and remote computer storage media including memory storage devices.

With reference to FIG. 10, an exemplary system for implementing aspects described herein includes a computing device, such as computing device 1000. In its most basic configuration, computing device 1000 typically includes at least one processing unit 1002 and memory 1004. Depending on the exact configuration and type of computing device, memory 1004 may be volatile (such as random access memory (RAM)), non-volatile (such as read-only memory (ROM), flash memory, etc.), or some combination of the two. This most basic configuration is illustrated in FIG. 10 by dashed line 1006.

Computing device 1000 may have additional features/functionality. For example, computing device 1000 may include additional storage (removable and/or non-removable) including, but not limited to, magnetic or optical disks or tape. Such additional storage is illustrated in FIG. 10 by removable storage 1008 and non-removable storage 1010.

Computing device 1000 typically includes a variety of computer readable media. Computer readable media can be any available media that can be accessed by the device 1000 and includes both volatile and non-volatile media, removable and non-removable media.

Computer storage media include volatile and non-volatile, and removable and non-removable media implemented in any method or technology for storage of information such as computer readable instructions, data structures, program modules or other data. Memory 1004, removable storage 1008, and non-removable storage 1010 are all examples of computer storage media. Computer storage media include, but are not limited to, RAM, ROM, electrically erasable program read-only memory (EEPROM), flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by computing device 500. Any such computer storage media may be part of computing device 1000.

Computing device 1000 may contain communication connection(s) 1012 that allow the device to communicate with other devices. Computing device 1000 may also have input device(s) 1014 such as a keyboard, mouse, pen, voice input device, touch input device, etc. Output device(s) 1016 such as a display, speakers, printer, etc. may also be included. All these devices are well known in the art and need not be discussed at length here.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited, but rather may be implemented in connection with any computing environment, such as a network or distributed computing environment. Still further, aspects of the presently disclosed subject matter may be implemented in or across a plurality of processing chips or devices, and storage may similarly be effected across a plurality of devices. Such devices might include personal computers, network servers, and handheld devices, for example.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed:

1. A method comprising:
receiving a query of whether to display at least one advertisement by a computing device, wherein the query identifies an entity;
in response to the query, retrieving advertisement information associated with the identified entity by the computing device;
determining that the retrieved advertisement information satisfies a condition by the computing device; and
in response to determining that the retrieved advertisement information satisfies the condition, providing an instruction not to display the at least one advertisement by the computing device.

2. The method of claim 1, wherein the query is received from one or more of an application, a web page, video game console, smart phone, or set-top box.

3. The method of claim 1, wherein retrieving advertisement information associated with the identified entity comprises retrieving a date stamp associated with the identified entity, and wherein determining that the retrieved advertisement information satisfies the condition comprises determining that the date stamp is not earlier than a current date.

4. The method of claim 1, wherein retrieving advertisement information associated with the identified entity comprises retrieving a count associated with the identified entity, and wherein determining that the retrieved advertisement information satisfies the condition comprises determining that the count is not less than a threshold count.

5. The method of claim 4, further comprising decrementing the count if the count is not less than the threshold count.

6. The method of claim 1, further comprising:
determining that the retrieved advertisement information does not satisfy the condition; and
in response to determining that the retrieved advertisement information does not satisfy the condition, providing an instruction to display the at least one advertisement.

7. The method of claim 1, further comprising:
receiving an indication of interest in the at least one advertisement, wherein the indication of interest identifies the entity; and
in response to the received indication of interest, updating the advertisement information based on the received indication of interest.

8. The method of claim 7, wherein the indication of interest in the at least one advertisement indicates one or more of selecting an advertisement of the at least one advertisement, viewing a video content item associated with the at least one advertisement, visiting a web page associated with the at least one advertisement, or downloading an application associated with the at least one advertisement.

9. The method of claim 7, wherein the advertisement information comprises a date stamp, and wherein updating the advertisement information comprises updating the date stamp to a date that is later than a current date.

10. The method of claim 7, wherein the advertisement information comprises a count, and wherein updating the advertisement information comprises incrementing the count by an amount.

11. A method comprising:
while executing an application by a computing device at a first time, displaying an advertisement in the application;
receiving an indication of interest in the displayed advertisement by the computing device;
in response to the indication of interest, updating advertisement information associated with the application based on the received indication of interest by the computing device;
while executing the application by the computing device at a second time after the first time, determining that the updated advertisement information satisfies a condition by the computing device; and
in response to the determination, not displaying the advertisement or a different advertisement in the application by the computing device.

12. The method of claim 11, wherein the advertisement information comprises a date stamp, wherein updating the advertisement information associated with the application based on the received indication of interest comprises updating the date stamp, and wherein determining that the updated advertisement satisfies the condition comprises determining that the date stamp is later than a current date.

13. The method of claim 11, wherein the advertisement information comprises a count, wherein updating the advertisement information associated with the application based on the received indication of interest comprises incrementing the count, and wherein determining that the updated advertisement satisfies the condition comprises determining that the count is greater than a threshold count.

14. The method of claim 13, further comprising decrementing the count in response to determining that the count is greater than the threshold count.

15. The method of claim 11, wherein the indication of interest in the displayed advertisement indicates one or more of selecting the advertisement, viewing a video content item associated with the advertisement, or visiting a web page associated with the advertisement.

16. The method of claim 11, further comprising displaying an offer to not display the advertisement, or the different advertisement in exchange for the indication of interest in the advertisement.

17. A system comprising:
at least one computing device adapted to execute an application; and
an advertisement engine adapted to:
receive a query from the application of whether to display an advertisement in the application;
in response to the query, retrieving a count associated with the application;
determine that the retrieved count is greater than a threshold count;
in response to determining that the count is greater than the threshold count, provide an instruction not to display the advertisement in the application and incrementing the count associated with the application.

18. The system of claim 17, wherein the advertisement engine is further adapted to:
determine that the retrieved count is not greater than the threshold count; and
in response to determining that the count is not greater than the threshold count, provide an instruction to display the advertisement in the application.

19. The system of claim 18, wherein the advertisement engine is further adapted to:
receive an indication of interest in the advertisement; and
in response to the indication of interest, increment the count associated with the application.

20. The system of claim 19, wherein the indication of interest in the advertisement indicates one or more of selecting the advertisement, viewing a video content item associated with the advertisement, or visiting a web page associated with the advertisement.
